(19) United States
(12) Patent Application Publication
(10) Pub. No.: US 2025/0306945 A1
(43) Pub. Date: Oct. 2, 2025

(54) METHOD AND APPARATUS FOR JUST-IN-TIME QUANTIZATION FOR MACHINE LEARNING

(71) Applicant: Advanced Micro Devices, Inc., Santa Clara, CA (US)

(72) Inventors: Mohamed Assem Abd ElMohsen Ibrahim, Santa Clara, CA (US); Adam Li, Solana Beach, CA (US); Shaizeen Aga, Santa Clara, CA (US)

(21) Appl. No.: 18/622,237

(22) Filed: Mar. 29, 2024

(51) Int. Cl. G06F 9/38; G06F 9/30

(52) U.S. Cl. CPC G06F 9/3885; G06F 9/30025; G06F 9/30043

(57) ABSTRACT

An apparatus and method for efficiently changing data formats of data values used by a machine learning data model. A computing system includes a processing circuit, memory, multiple accelerators, and a control circuit. The processing circuit executes mixed precision training operations for a machine learning (ML) data model. Rather than have the parallel data processing circuit perform quantization operations as well as the vector operations 110 and combine operations, the control circuit finds an available accelerator of the multiple accelerators to perform the quantization operation. Rather than have the output values of the quantization operation reside in the memory during the iterative operations of the training operations, the control circuit predicts when the parallel data processing circuit requires the output value, when the quantization operation should begin, and when the output value can be removed from memory.

### BACKGROUND

### Description of the Relevant Art

Machine learning (ML) data models are used in a variety of applications in a variety of fields such as physics, chemistry, biology, engineering, social media, finance, and so on. ML data models use one or more layers of nodes to classify data in order to provide an output value representing a prediction when given a set of inputs. Weight values are used to determine the amount of influence that a change in a particular input data value will have upon a particular output data value within the one or more layers of the ML data model. The cost of training and using an ML data model includes providing hardware resources that can process the relatively high number of computations and can support the data storage and the memory bandwidth for accessing parameters. These parameters include the input data values, the weight values, bias values, and other values. If an organization cannot support the cost of training and using the ML data model, then the organization is unable to benefit from the ML data model.

In view of the above, methods and apparatuses for changing data formats of data values used by a machine learning data model are desired.

### BRIEF DESCRIPTION OF THE DRAWINGS

FIG. 1 is a generalized diagram of a computing system that efficiently changes data formats of data values used by a machine learning data model.

FIG. 2 is a generalized diagram of a computing system that efficiently changes data formats of data values used by a machine learning data model.

FIG. 3 is a generalized diagram of an apparatus that efficiently changes data formats of data values used by a machine learning data model.

FIG. 4 is a generalized diagram of a method that efficiently changes data formats of data values used by a machine learning data model.

FIG. 5 is a generalized diagram of a computing system that efficiently changes data formats of data values used by a machine learning data model.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

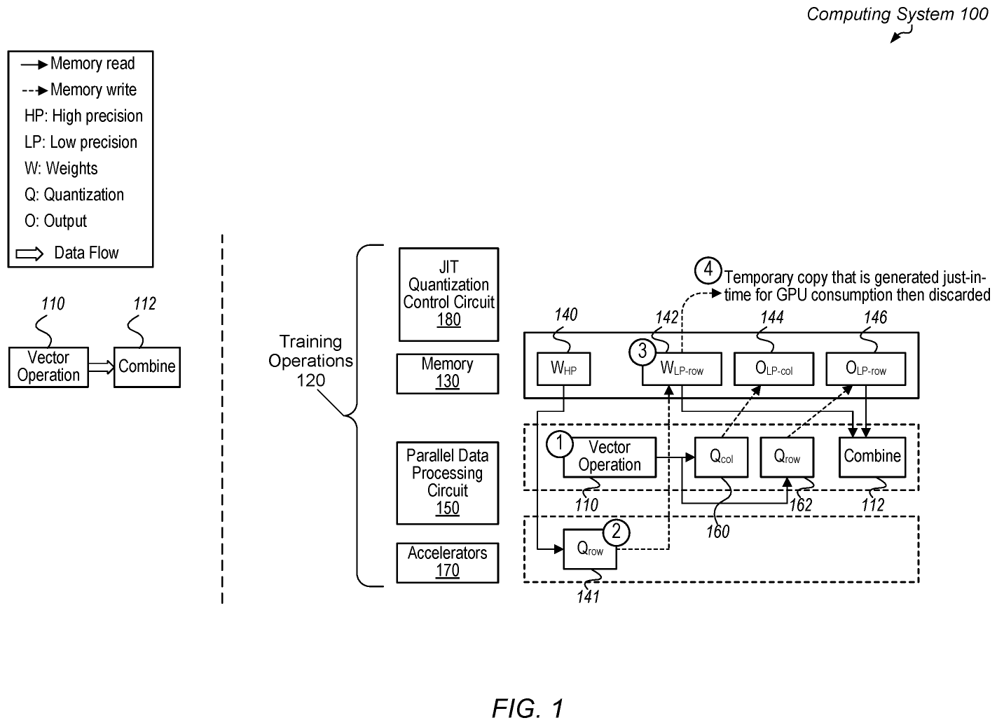

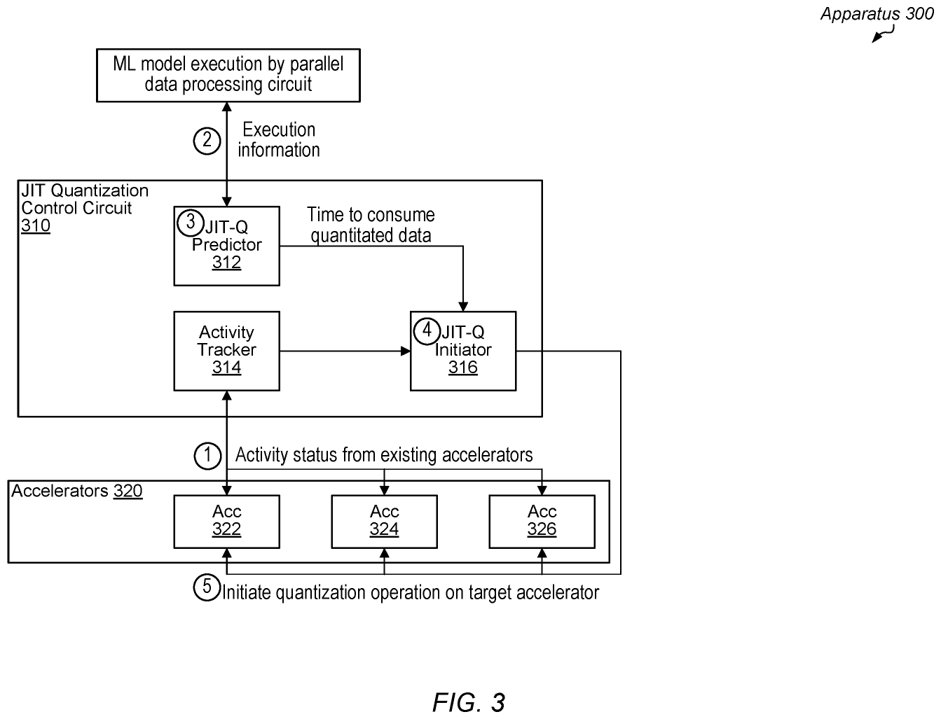

Systems and methods that change data formats of data values used by a machine learning data model are disclosed herein. In various implementations, a computing system includes a processing circuit, memory, multiple accelerators, and a control circuit. The processing circuit executes mixed precision training operations for a parallel data application such as an application providing a machine learning (ML) data model. Rather than have the parallel data processing circuit perform quantization operations as well as vector operations and combine operations, the control circuit selects an available accelerator of the multiple accelerators to perform the quantization operation. The control circuit selects one or more accelerators based at least upon monitored activity levels of the accelerators, the type of operations currently being performed by the parallel data application, and the data sizes of the weight values. Further details of the activity levels and selection criteria are provided in the description of apparatus 300 (of FIG. 3). Rather than have the output values of the quantization operation reside in the memory during the iterative operations of the training operations, the control circuit predicts a first point in time when the parallel data processing circuit requires the output value, a second point in time when the quantization operation should begin, and a third point in time when the output value can be removed from memory. Further details of performing these predictions are provided in the description of apparatus 300 (of FIG. 3). Additionally, further details of these techniques that create less computationally intensive nodes for a machine learning data model are provided in the following description of FIGS. 1-5.

Turning now to FIG. 1, a generalized diagram is shown of a computing system 100 configured to change data formats of data values used by a machine learning data model. As shown, computing system 100 includes memory 130, parallel data processing circuit 150, and multiple accelerators 170. In various implementations, parallel data processing circuit 150 executes operations to support a machine learning (ML) data model. Memory 130 stores a variety of values used during training of the ML data model such as weight values. To reduce the number of copies of at least the weight values stored in memory 130, selected one or more accelerators of accelerators 170 are used to generate copies of the weight values stored in memory 130 and then remove these copies from memory 130 when parallel data processing circuit 150 has finished using the copies of the weight values. Each of the accelerators 170 is different from the parallel data processing circuit 150 executing the data model. Parallel data processing circuit 150 is also free to work on other tasks when the selected one or more accelerators of accelerators 170 generate the copies of the weight values.

The just-in-time (JIT) quantization control circuit 180 (or control circuit 180) predicts when parallel data processing circuit 150 requires the copies of the weight values, such as at least weight value 142, and selects one or more accelerators of the multiple accelerators 170 to assign the task of generating the copies of the weight values. At a later point in time, one or more of the parallel data processing circuit 150 and the control circuit 180 generates an indication specifying when the parallel data processing circuit 150 has completed accessing the copies of the weight values. This indication causes one of the parallel data processing circuit 150 and the selected one or more accelerators of accelerators 170 to remove the copies of the weight values from memory 130. Before describing the sequence of actions 1 to 4 (circled numbers), further details of the components of computing system 100 are provided.

It is also noted that the number of components of computing system 100 and the number of subcomponents can vary from implementation to implementation. There can be more or fewer of each component/subcomponent than the number shown for computing system 100. In other implementations, computing system 100 includes other components and/or computing system 100 is arranged differently. For example, power management circuitry, phased locked loops (PLLs) or other clock generating circuitry, other processing circuits, input/output (I/O) interfaces, a bus or a communication fabric, a network interface, and so forth are not shown for ease of illustration. In various implementations, the components of computing system 100 are on the same die such as a system-on-a-chip (SOC). In other implementations, the components are individual dies in a system-in-package (SiP) or a multi-chip module (MCM).

In some implementations, memory 130 is off-chip system memory that uses multiple memory array banks (not shown). In various implementations, the memory array banks provide data storage of one of a variety of types of dynamic random-access memory (DRAM). The data storage includes a type of dynamic random-access memory that stores each bit of data in a separate capacitor within an integrated circuit. The capacitor can be either charged or discharged. These two states are used to represent the two logical values (Boolean values) of a bit (binary digit). The memory array bank of memory 130 utilizes a single transistor and a capacitor per bit, which provides higher data storage density than the typical six transistor (6T) memory cells of on-chip synchronous RAM (SRAM). Unlike hard disk drivers (HDDs) and flash memory, the memory array bank can be volatile memory, rather than non-volatile memory. The memory array bank can lose its data quickly when power is removed. In other implementations, memory 130 is dedicated local memory for parallel data processing circuit 150, and the memory array banks include on-chip synchronous RAM (SRAM). In such an implementation, parallel data processing circuit 150 and memory 130 utilize a point-to-point (P2P) communication protocol.

In various implementations, one or more memory array banks of memory 130 utilize components of a processing-in-memory (PIM) accelerator. These components include at least a PIM arithmetic logic unit (ALU) 150, a PIM register file, and a PIM accumulation register. The components of the PIM accelerator integrate data processing capability with data storage within the same memory device. The PIM ALU 150 performs a variety of operations based on a received command. The PIM register file stores source operands, destination operands or result operands, and intermediate data values. In various implementations, the PIM ALU is capable of performing quantization operations and dequantization operations dynamically, which offloads parallel data processing circuit 150 from performing these operations. By having a workload that includes the quantization operations and/or dequantization operations offloaded from parallel data processing circuit 150, parallel data processing circuit 150 is allowed to process other types of workloads without further delay.

Although accelerators 170 are shown as being located together, in various implementations, the individual accelerators of accelerators 170 can be separated from one another and located across computing system 100. For example, the PIM ALUs are located within memory 130. Other types of computing resources can be included as accelerators 170 capable of overlapping quantization operations and/or dequantization operations with other types of computations performed by parallel data processing circuit 150. Each of the computing resources included as accelerators 170 is different from the parallel data processing circuit 150 executing a parallel data application such as a machine learning (ML) data model. Examples of these other types of computing resources included as accelerators 170 are direct memory access (DMA) circuits, artificial intelligence engine (AIE) circuits, digital signal processing circuits (DSPs), field programmable gate arrays (FPGAs), application specific integrated circuits (ASICs), and so forth. As there are accelerators of the accelerators 170 capable of overlapping quantization operations and/or dequantization operations with other types of computations performed by parallel data processing circuit 150, the accelerators 170 can efficiently change the data format of data values (e.g., weight values, activation values, gradient values, and other data values) used by the ML data model.

In some implementations, parallel data processing circuit 150 uses a highly parallel data microarchitecture and includes the circuitry of one or more processor cores with a single instruction multiple data (SIMD) parallel microarchitecture. Parallel data processing circuit 150 can be a discrete device, such as a dedicated GPU (dGPU), or the processing circuit 102 can be integrated (an iGPU) in the same package as another processing circuit. Other parallel data processing circuits that can be included in computing system 100 include digital signal processing circuits (DSPs), field programmable gate arrays (FPGAs), application specific integrated circuits (ASICs), and so forth.

In some implementations, parallel data processing circuit 150 includes multiple, replicated compute circuits, each including similar circuitry such as multiple parallel lanes of execution. A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner. In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.” Tasks performed by compute circuits of parallel data processing circuit 150 can be grouped into a “workgroup” that includes multiple thread groups (or multiple wavefronts).

In some implementations, parallel data processing circuit 150 executes a highly parallel data application that includes particular function calls using an application programming interface (API) to allow the developer to dispatch wavefronts of a kernel (function call) to the parallel lanes of execution of parallel data processing circuit 150. In an implementation, the function call is a C++ object, and it is converted by a general-purpose processing circuit, such as a central processing unit (CPU), to a command. An example of the highly parallel data application executed by parallel data processing circuit 150 is a machine learning (ML) data model. Examples of the types of the machine learning data model are one of multiple types of convolutional machine learning data models, deep machine learning data models, and recurrent machine learning data models.

The machine learning data model classifies data in order to provide output data that represents a prediction when given a set of inputs. To do so, the machine learning data model uses an input layer, one or more hidden layers, and an output layer. Each of these layers has one or more neurons (or nodes). Each of these neurons receives input data from the input layer. In the one or more hidden layers and the output layer, each of the neurons receives input data as output data from one or more neurons of a previous layer. These neurons also receive one or more weight values that are combined with corresponding input data. Typically, the neurons use matrix multiplication, such as General Matrix Multiplication (GEMM) operations, to perform the combining step. A vector operation 110 and a combine operation 112 are shown.

Vector operation 110 can be one of a variety of multi-element (or vector) arithmetic operations such as addition, a Boolean arithmetic operation, or other. The ML data model training operations 120 repeatedly use at least the vector operation 110, the quantization operation 141, and the combine operation 112. Rather than have parallel data processing circuit 150 perform quantization operations as well as the vector operation 110 and the combine operation 112, control circuit 180 finds an available accelerator of accelerators 170 to perform the quantization operation such as quantization operation 141. Rather than have the output values of the quantization operation reside in memory 130 during the iterative operations of the training operations 120, control circuit 180 predicts a first point in time when parallel data processing circuit 150 requires the output value, such as weight value 142, a second point in time when the quantization operation 141 should begin, and a third point in time when the output value, such as weight value 142, can be removed from memory 130. Further details of performing these predictions are provided in the description of apparatus 300 (of FIG. 3).

As described earlier, control circuit 180 selects one or more accelerators of accelerators 170 to dynamically perform quantization operations and/or dequantization operations. Control circuit 180 selects one or more accelerators based at least upon monitored activity levels of the accelerators 170, the type of operations currently being performed by the ML data model, and the data sizes of the weight values. Further details of the activity levels and selection criteria are provided in the description of apparatus 300 (of FIG. 3). When the selected one or more accelerators of accelerators 170 performs a quantization operation, the one or more accelerators replace a first magnitude of a first data value using a first precision with a second magnitude of the first data value using a second precision less than the first precision. As used herein, the term “precision” is used to refer to a data size, such as a bit width, that is a number of bits used to represent a magnitude of a particular data value. Precisions are used to provide a higher or lower accuracy of the same magnitude of a particular data value. When the first magnitude of the particular data value is represented by 32 bits, the accuracy and precision of the first magnitude is higher than a second magnitude of the particular data value represented by 8 bits.

When computing system 100 uses a floating-point format, each of the weight values includes a corresponding mantissa and a corresponding exponent. A sum of the number of bits of the mantissa and the number of bits of the exponent equals the total data size of a particular weight value represented in the floating-point format. The precision of the floating-point number is equal to the size of the mantissa. Typically, a 32-bit floating-point data format includes the significand, which is also referred to as the mantissa, with a size of 23 bits and an exponent with a size of 8 bits. The 32-bit floating-point data format typically includes an implicit bit, which increases the size of the significand to 24 bits. Therefore, the typical 32-bit floating-point value has a precision of 24 bits. In an implementation, memory 130 stores a single copy of a data value, such as a weight value, in a single precision such as the precision of the 32-bit IEEE-754 single-precision floating-point data format. In some implementations, when performing an offloaded quantization operation, the selected one or more accelerators of accelerators 170 generate a copy of the data value (weight value) with a reduced (lowered) precision such as the precision of the 16-bit bfloat16 data format, the 8-bit fixed-point int8 integer data format, or another lower precision. In this case, the copy of the data value (weight value) has a precision with a data size less than the 24 bits of the typical 32-bit floating-point value of the original data value (weight value) stored in memory 130.

Memory 130 stores a data value having a first magnitude using a first precision (e.g., 32-bit floating-point data format). During the quantization operation, the term “replace” is used to refer to the generation of the data value having a second magnitude using a second precision (e.g., 8-bit fixed-point int8 integer data format) less than the first precision (e.g., 32-bit floating-point data format). However, the copy of the data value having the first magnitude using the first precision is retained in memory 130. For example, memory 130 stores weight value 140, which is a copy of a data value represented by high precision (e.g., 32-bit IEEE 754 single precision floating-point data format), and memory 130 temporarily stores weight value 142, which is a copy of the same data value represented by low precision (e.g., 8-bit fixed-point int8 integer data format). During the offloaded quantization operation, the selected accelerator of accelerators 170 generates the data value in the 8-bit fixed-point int8 integer data format (weight value 142) from the copy of the data value stored in memory 130 using the precision of the 32-bit IEEE-754 single-precision floating-point data format (weight value 140). The selected accelerator replaced the first magnitude of the data value using the first precision with the second magnitude of the data value using the second precision less than the first precision. However, the original copy of the data value (weight value 140) using the first precision of the 32-bit IEEE-754 single-precision floating-point data format continues to be retained in memory 130. Similarly, during the dequantization operation, the term “replace” is used to refer to the generation of the data value having a second magnitude using a second precision (e.g., 16-bit bfloat16 data format) greater than the first precision (e.g., 8-bit fixed-point int8 integer data format). The original copy of the data value using the first precision (e.g., 16-bit bfloat16 data format) can be retained in memory 130.

Mixed precision techniques enable the use of different data formats during a single iteration of training a ML data model. Mixed precision techniques can reduce data movement and increase arithmetic operations throughput by using highly parallel data throughput of parallel data processing circuit 150. Therefore, weight values, activation values, gradient values and other types of data values are stored in memory 130 using low precision data formats. However, to prevent the loss of critical information due to the use of low precision data formats and preserve the accuracy of performing training operations 120 with high precision data formats, a high precision copy of the weight values is maintained in memory 130. These high precision copies of weight values are updated during the optimizer step of training operations 120. As described earlier, in an implementation, memory 130 stores weight value 140, which is a copy of a data value represented by high precision (e.g., 32-bit floating-point data format), and memory 130 temporarily stores weight value 142, which is a copy of the same data value represented by low precision (e.g., 8-bit fixed-point int8 integer data format). Since in some implementations, training operations 120 utilizes a modern data format, such as the microexponent (MX) sharing data format, memory 130 can temporarily store two low precision copies of the weight value (weight value 140). The number of temporary copies maintained in memory 130 is reduced from two to one and then to zero by steps performed by control circuit 180. Without such a reduction in the number of copies maintained in memory 130, memory 130 fills more quickly.

As shown, during sequence 1, parallel data processing circuit 150 performs vector operation 110. During this time, control circuit 180 has selected an accelerator of accelerators 170 and assigned (or scheduled) tasks to the selected accelerator that include performing a quantization operation on weight values required for the subsequent combine operation 112. Although the description of the sequences 1-4 describes a single accelerator being selected to quantize weight values of the ML data model, it is possible and contemplated that control circuit 180 selects two or more accelerators of accelerators 170 to quantize weight values, activation values, gradient values, and other types of data values. As described earlier, control circuit 180 selects the one or more accelerators based at least upon monitored activity levels of the accelerators 170, the type of operations currently being performed by the ML data model, and the data sizes of the data values to be quantized. Further details of the activity levels and selection criteria are provided in the description of apparatus 300 (of FIG. 3). It is also possible and contemplated that control circuit 180 selects an accelerator of accelerators 170 to dynamically perform a dequantization operation of data values while one or more other accelerators of accelerators 170 perform quantization operations. The parallel data processing circuit 150 and the selected accelerator processes data values using a variety of data formats such as a 32-bit floating-point data format, the 16-bit bfloat16 data format, the 8-bit fixed-point int8 integer data format, one of a variety of types of directional blocked data formats, one of a variety of types of scalar data formats, and so forth.

During sequence 2, the selected accelerator performs the assigned quantization operation 141 to generate the weight value 142 from the weight value 140. During sequence 3, the selected accelerator stores the generated weight value 142 in memory 130. Parallel data processing circuit 150 generates the output values 144 and 146 by performing other operations 160 and 162, respectively. Afterward, during sequence 4, parallel data processing circuit 150 uses the weight value 142 in a combine operation with at least output value 146. Offloading quantization operation 141 from parallel data processing circuit 150 to the selected accelerator removes the latency of quantization operation 141 from the data flow path of parallel data processing circuit 150. In various implementations, the weight value 142 is a temporary value stored in memory 130. After parallel data processing circuit 150 uses weight value 142 in the combine operation 112, one or more of the control circuit 180, a memory controller of memory 130, and the selected accelerator removes the weight value 142 from memory 130. The corresponding data storage location in memory 130 can be reused by other data.

As used herein, the removal operation used to “remove a data value from memory” can refer to one or more operations that cause a data storage location storing the data value to become an unprotected data storage location. An example of the removal operation is invalidating the data storage location, such as a cache line, that stores the data value. In an implementation, the data storage location can be a cache line of a vector cache being used as scratch pad memory for the parallel data processing circuit 150 or another cache of a cache memory subsystem. Another example of the removal operation is allowing the data value in the data storage location of the memory to be overwritten after parallel data processing circuit 150 uses weight value 142 in the combine operation 112. An invalidation step is not performed, but the data storage location is unprotected. Although weight value 142 can remain in memory 130 after parallel data processing circuit 150 uses weight value 142 in the combine operation 112, the data storage location storing weight value 142 can be overwritten at any time, whereas the data storage location storing weight value 140 cannot be overwritten until the highly parallel data application executed by parallel data processing circuit 150 has completed.

The overwriting step for the data storage location of weight value 142 can be done to store other weight values of low precision for later steps or later layers of the data model provided by the highly parallel data application. In this manner, those data storage locations continue to be reused and overwritten. The data storage location for weight value 142 is protected data storage space only between a point in time of the generation of weight value 142 and a point in time of the parallel data processing circuit 150 has used weight value 142 in the combine operation 112. After parallel data processing circuit 150 uses weight value 142 in the combine operation 112, the data storage location storing weight value 142 becomes unprotected. Another example of the removal operation is updating pointers specifying a queue or a memory region to indicate particular data storage locations are no longer allocated. These data storage locations continue to store data values, but these data storage locations are unprotected from being overwritten. The pointers are again updated upon completion of the overwriting operations that store new data values in these data storage locations.

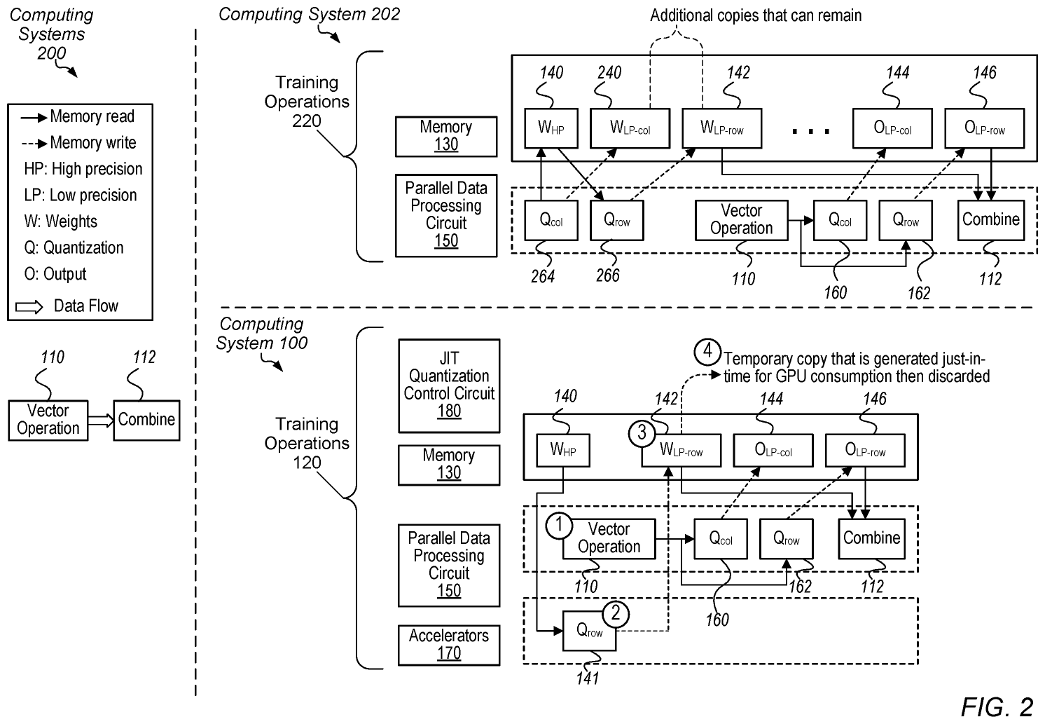

Turning now to FIG. 2, a generalized diagram is shown of computing systems 200 that efficiently changes data formats of data values used by a machine learning data model. Circuitry and components previously described are numbered identically. As shown, computing systems 200 includes computing system 100 that utilizes control circuit 180 to perform training operations 120 and computing system 202 that does not utilize control circuit 180 to perform training operations 220. As described earlier, training operations 120 uses at least the vector operation 110, the quantization operation 141, and the combine operation 112. Training operations 202 uses at least the vector operation 110, quantization operations 264 and 266, and the combine operation 112. Since computing system 202 does not utilize control circuit 180, the computing system 202 stores more weight values in memory 130, such as weight values 240 and 142 (not discarded after use), and parallel data processing circuit 150 of computing system 202 performs additional quantization operations 264 and 266. Without using control circuit 180 and offloading tasks to accelerators 170, the capacity of memory 130 in computing system 202 fills faster and the latency increases for parallel data processing circuit 150 to perform training operations 220.

Turning now to FIG. 3, a generalized diagram is shown of an apparatus 300 that efficiently changes data formats of data values used by a machine learning data model. As shown, apparatus 300 includes just-in-time (JIT) quantization control circuit 310 (or control circuit 310) and accelerators 320. In an implementation, control circuit 310 includes just-in-time (JIT) quantization (JIT-Q) predictor 312 (or predictor 312), activity tracker 314, and just-in-time (JIT) quantization (JIT-Q) initiator 316 (or initiator 316). In various implementations, control circuit 310 has the same functionality as control circuit 180 (of FIG. 1) and accelerators 320 have the same functionality as accelerators 170 (of FIG. 1).

A timing sequence with sequences 1 to 5 is shown. For purposes of discussion, the timing sequence in this implementation is shown in sequential order. However, in other implementations some sequences occur in a different order than shown, some sequences are performed concurrently, some sequences are combined with other sequences, and some sequences are absent. At sequence 1, during execution of mixed precision training operations for a ML data model, activity tracker 314 sends a request to accelerators 322-326 requesting indications of an activity level. Examples of the indications are a busy or idle flag, presently used operating parameters (e.g., power supply voltage, clock frequency, power-performance state), values stored in a variety of types of performance counters, expected time to transition to being busy, expected time to transition to being idle, and so forth. Rather than wait for requests from activity tracker 314, accelerators 322-326 can send information directed toward activity level after a threshold period of time has elapsed. Activity tracker 314 can store the received information in one or more data structures for later analysis when control circuit 310 generates an indication specifying which accelerator will perform an upcoming quantization operation.

During sequence 2, predictor 312 interacts with the parallel data processing circuit that executes the mixed precision training operations for the ML data model. An example of information that the parallel data processing circuit sends to predictor 312 is the one or more current operators in a given layer (e.g., encoder block) in a large language model (LLM). The model structure can be one of the existing formats that represent machine learning models (e.g., ONNX). These formats define a directed graph in which each edge represents a tensor with a specific type that is moving from one operator to the other. Therefore, predictor 312 receives indications specifying the types of operations being performed by the parallel data processing circuit. In some implementations, predictor 312 also receives an indication from a memory controller specifying the available capacity of the memory storing data values being processed by the parallel data processing circuit as the parallel data processing circuit executes the ML data model.

During sequence 3, with knowledge of the executed model structure and tensor sizes, knowledge of the types of operations being performed by the parallel data processing circuit, knowledge of the available capacity of the memory and along with indications specifying the activity level of the parallel data processing circuit, predictor 312 generates a prediction directed to an upcoming point in time that the parallel data processing circuit will read a quantized weight value or other value from memory. In other words, predictor 312 predicts the point in time when the parallel data processing circuit will need the quantized weights to be available in memory for consumption during a combine operation (e.g., a GEMM operation). For example, predictor 312 generates a prediction of a first point in time that the parallel data processing circuit will require the data value in a second precision to be available in a memory array bank or other partition of the memory. Predictor 312 also generates a prediction of a second point in time, based on the first point in time and being earlier than the first point in time, to begin generating the data value in the second precision.

In some implementations, the points in time (e.g., predicted first point in time, predicted second point in time) are specified by particular layers of the multiple layers of the machine learning data model provided by the parallel data application. The above predicted first point in time can be specified by layer 39 of the machine learning data model and the above predicted second point in time can be specified by layer 35 of the machine learning data model. Therefore, upon receiving an indication that layer 35 (predicted second point in time) has begun being processed by the parallel data processing circuit, predictor 312 generates an indication specifying that a selected accelerator should begin generating the data value in the second precision by the start of processing of layer 35 so as to ensure that the data value in the second precision will be available in a memory array bank or other partition of the memory by the start of processing of layer 39 (predicted first point in time) of the machine learning data model. In other implementations, the points in time are specified by particular counts of clock cycles that have elapsed since the beginning of processing of layer 1 (or another layer) of the machine learning data model. In yet other implementations, one of a variety of other types of indications specifying elapsed time are used to identify the predicted points in time.

Using the information from the activity tracker 314 and predictor 312, during sequence 4, initiator 316 selects one or more of the accelerators 322-326 to generate the quantized weights for consumption by the parallel data processing circuit. It is also possible and contemplated that control circuit 310 selects an accelerator of accelerators 320 to dynamically perform a dequantization operation of data values. In some implementations, one or more accelerators of accelerators 320 perform a dequantization operation concurrently while one or more other selected accelerators of accelerators 320 perform quantization operations. In another implementation, one or more accelerators of accelerators 320 perform a dequantization operation at a different point in time when one or more other selected accelerators of accelerators 320 perform quantization operations. However, each of the quantization operations and the dequantization operations occur while the parallel data processing circuit performs other operations. As there are accelerators of the accelerators 320 capable of overlapping quantization operations and/or dequantization operations with other types of computations performed by the parallel data processing circuit executing the machine learning (ML) data model, the accelerators 320 can efficiently change the data format of data values (e.g., weight values, activation values, gradient values, and other data values) used by the ML data model.

Following selection of one or more accelerators of accelerators 320 by initiator 316, during sequence 5, initiator 316 sends an indication to the selected one or more accelerators of accelerators 322-326 specifying the operation to perform (e.g., quantization operation) and the source data (e.g., high precision weight value). In some implementations, initiator 316 can divide the quantization tasks into multiple independent subtasks to be processed in parallel by multiple available accelerators of accelerators 322-326. This can be helpful in case it is challenging to get the required quantized data before the predicted consumption time. In an implementation, initiator 316 considers load balancing between accelerators of accelerators 322-326 so as not to overuse one accelerator over another accelerator. In some implementations, initiator 316 prioritizes performance-per-watt, rather than performance alone. A higher priority level can also be assigned to reducing data movement. For example, in the case of favoring data movement reduction, a PIM-based accelerator is favored over other types of accelerators. A higher priority level can also be assigned to an accelerator with large on-chip storage.

In some implementations, when performing quantization operations, an accelerator of accelerators 320, such as accelerator 322, performs the quantization operation based on a memory address range of the memory storage location storing the data value to quantize. In an implementation, the data format of the original copy of the data value is the 32-bit floating-point data format, and the memory address range of the memory storage location storing the data value to quantize is between 32×0000 0000 and 32×0000 0FFF, where “32×” denotes a 32-bit hexadecimal value. In this case, the accelerator 322 changes the data format of the data value from the 32-bit floating-point format to the 16-bit bfloat16 data format. For another data value using the 32-bit floating-point data format, the memory address range of the memory storage location storing the other data value to quantize is between 32×00FF FFFF and 32×00FF 1000. Based on this other memory address range, accelerator 322 changes the data format of the data value from the 32-bit floating-point format to the 8-bit fixed-point int8 integer data format. For another address range, accelerator 322 changes the data format of the data value from the 32-bit floating-point format to yet another data format. In some implementations, the memory address ranges and an indication specifying the corresponding data format to use during a quantization operation are stored in programmable configuration registers.

To perform the required quantization, the selected one or more accelerators of accelerators 320 would execute memory accesses at the same time the parallel data processing circuit accesses the memory. These concurrent accesses of the memory cause contention at the memory controller between the quantization-induced memory requests and training computation memory requests. In some implementations, the control circuit 310 tags memory requests to differentiate between training computation memory accesses of the parallel data processing circuit and the quantization memory accesses of the selected accelerator. Control circuit 310 can assign and later update priority levels of the tags.

In an implementation, one or more of the accelerators 320 disables reporting of or requesting for indications of activity level. In some implementations, when the computing system includes a large number of accelerators, control circuit 310 initiates quantization operations required for future training operations ahead of time on the multiple, available accelerators. For example, when parallel processing circuit processes layer i, accelerator 322 quantizes the data for layer i+1, accelerator 324 quantizes the data for layer i+2, and so on. However, this will require more temporary copies of weight values stored in memory. The number, though, of copies is still lower than maintaining copies for all the layers across the training operations. However, in another implementation, control circuit 310 keeps track of the number of existing temporary copies stored in memory and decides to skip performing more quantization operations when the number exceeds a threshold.

In an implementation, control circuit 310 assigns priority levels to accelerators 322-326. For example, offloading quantization operations to PIM accelerators can be preferred due to already being connected to data storage. Additionally, a PIM accelerator can be placed at different points in the memory pipeline (e.g., at memory controller, near DRAM banks in memory). Third, with PIM implementations (e.g., via near-DRAM banks ALU), the data movement can significantly reduce. Further, a PIM accelerator provides high memory bandwidth. DMA circuits can have a second highest priority level for selection, in an implementation. At a later point in time, one or more of the control circuit 310 and the parallel data processing circuit executing the ML data model generates an indication specifying when the parallel data processing circuit has completed accessing the copies of the data values (e.g., weight values, activation values, gradient values, and other data values) used by the ML data model and generated by the accelerators 320 with the changed data formats. As described earlier, predictor 312 interacts with the parallel data processing circuit that executes the mixed precision training operations for the ML data model. Predictor 312 uses this indication specifying when the parallel data processing circuit has completed accessing the copies of the data values to generate the predicted third point in time when the data value(s) in at least the second precision can be removed from memory. As described earlier regarding the predicted first point in time and the predicted second point in time, one of a variety of types of indications (e.g., layer number, count of clock cycles, other) specifying elapsed time are used to identify the predicted third point in time.

In an implementation, when predictor 312 receives an indication specifying that the parallel data processing circuit has completed accessing at least the data value in the second precision by the completion of layer 56 of the machine learning data model, predictor 312 generates an indication specifying layer 57 as the predicted third point in time when the data value in the second precision can be removed from memory. In some implementations, this generated indication causes the selected one or more accelerators of accelerators 320 to remove these copies of data values, such as the data value in the second precision, from memory. In another implementation, another processing circuit, such as the parallel data processing circuit, removes these copies of data values from memory based on this generated indication by predictor 312. Accelerators 320 or another processing circuit perform a removal operation as described earlier regarding sequence 4 of computing system 100 (of FIG. 1).

Modern directional data formats, such as the microexponent (MX) sharing data format, in higher dimensional tensors (e.g., 3D, 4D, etc.) can result in maintaining more additional copies of the same data due to sensitivity to reduction dimension when control circuit 310 is not used. Further, in addition to being used for quantization operations, control circuit 310 can also be used for other preprocessing operations (e.g., transpose) where the computation graph is known. In some implementations, control circuit 310 is located in the parallel data processing circuit. In other implementations, control circuit 310 can be a standalone circuit interacting with the parallel data processing circuit and accelerators 320. Further subcomponents of control circuit 310 can be placed in different locations and different dies across a computing system. In an implementation, predictor 312 can be used as part of the command processing circuit (command processor) of a GPU. One or more of the activity tracker 314 and initiator 316 can be implemented in the different accelerators to locally track information used to select accelerators and determine whether execution can begin for a particular accelerator. In such an implementation, initiator 316 would receive a “time to start quantization” indication from predictor 312 and locally determine if it possible to begin JIT quantization. Initiator 316 would send a response to predictor 312 indicating whether JIT quantization can proceed.

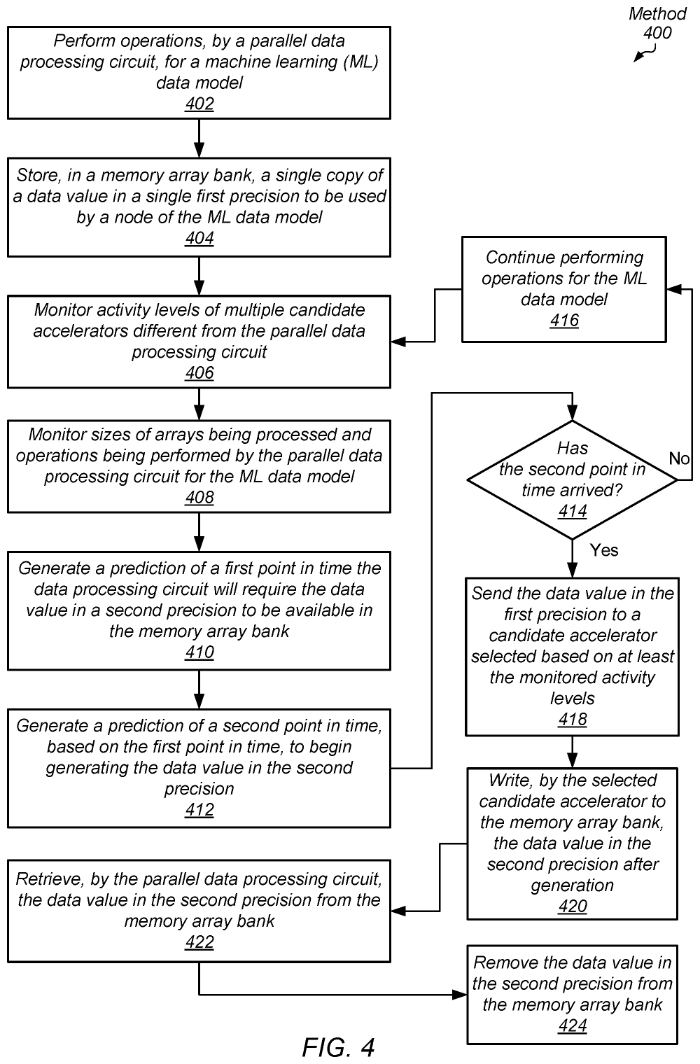

Referring to FIG. 4, a generalized diagram is shown of a method 400 that efficiently changes data formats of data values used by a machine learning data model. For purposes of discussion, the steps in this implementation are shown in sequential order. However, in other implementations some steps occur in a different order than shown, some steps are performed concurrently, some steps are combined with other steps, and some steps are absent.

A parallel data processing circuit performs operations for a machine learning data model (block 402). In various implementations, the operations correspond to steps performed during training steps or inference steps of a corresponding machine learning data model. A memory array bank stores a single copy of a data value in a single precision to be used by a machine learning data model node (or node) (block 404). A control circuit monitors activity levels of multiple candidate accelerators different from the parallel data processing circuit (block 406). The control circuit monitors sizes of arrays being processed and operations being performed by the parallel data processing circuit for the ML data model (block 408).

The control circuit generates a prediction of a first point in time that the data processing circuit will require the data value in a second precision to be available in the memory array bank (block 410). Generate a prediction of a second point in time, based on the first point in time, to begin generating the data value in the second precision (block 412). If the second point in time has not yet arrived (“no” branch of the conditional block 414), then the parallel data processing circuit continues performing operations for the ML data model (block 416). Afterward, control flow of method 400 returns to block 406 where the control circuit monitors activity levels of multiple candidate accelerators different from the parallel data processing circuit.

If the second point in time has arrived (“yes” branch of the conditional block 414), then the control circuit sends the data value in the first precision to a candidate accelerator of the multiple accelerators that has been selected based on at least the monitored activity levels (block 418). The selected candidate accelerator writes, to the memory array bank, the data value in the second precision after generation (block 420). The parallel data processing circuit retrieves the data value in the second precision from the memory array bank (block 422). The control circuit removes the data value in the second precision from the memory array bank (block 424).

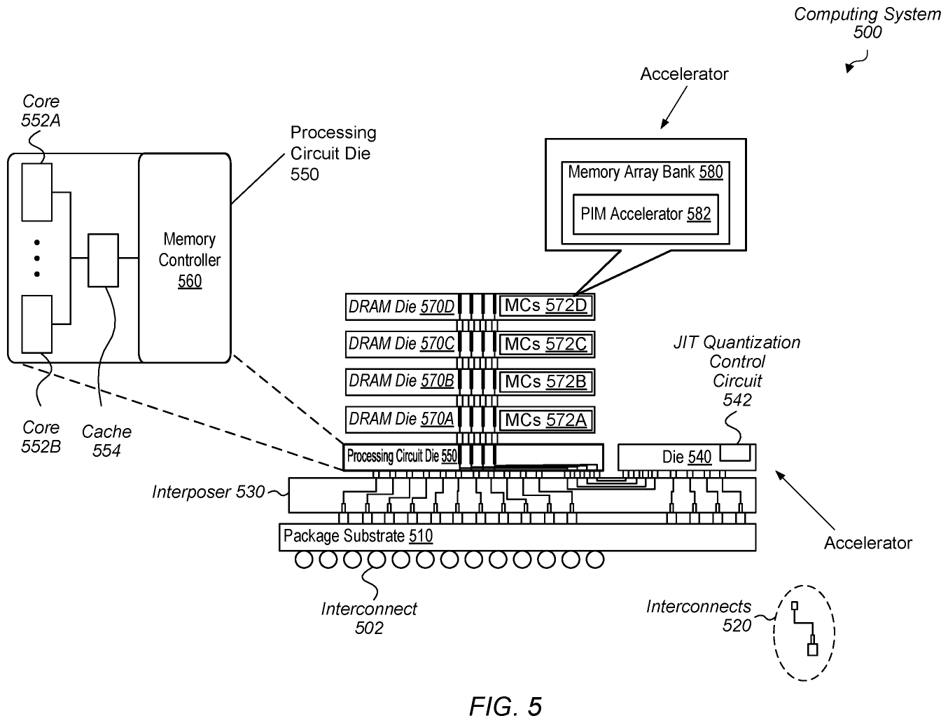

Turning now to FIG. 5, a generalized diagram is shown of a computing system 500 that efficiently changes data formats of data values used by a machine learning data model. The computing system 500 utilizes three-dimensional (3D) packaging. This type of packaging can be referred to as a System in Package (SiP). A SiP includes one or more three-dimensional integrated circuits (3D ICs). A 3D IC includes two or more layers of active electronic components integrated both vertically and/or horizontally into a single integrated circuit. In the illustrated implementation, computing system 500 includes the processing circuit die 550, the die 540, and multiple three-dimensional (3D) DRAM dies 570A-570D. The DRAM dies 570A-570D provide a high bandwidth memory (HBM) for the processing circuit die 550 and the die 540. Each of the DRAM dies 570A-570D includes respective, multiple memory channels (MCs) 572A-572D. Although a particular number of components is shown in the computing system 500, it is possible and contemplated that the number and types of components change in other implementations based on design requirements.

In various implementations, each of the MCs 572A, 572B, 572C and 572D includes multiple array banks (not shown). In various implementations, the memory array banks provide data storage of one of a variety of types of dynamic random-access memory (DRAM). The data storage includes a type of dynamic random-access memory that stores each bit of data in a separate capacitor within an integrated circuit. The capacitor can be either charged or discharged. These two states are used to represent the two logical values (Boolean values) of a bit (binary digit). The memory array banks utilize a single transistor and a capacitor per bit, which provides higher data storage density than the typical six transistor (5T) memory cells of on-chip synchronous RAM (SRAM). Unlike hard disk drivers (HDDs) and flash memory, the memory array bank can be volatile memory, rather than non-volatile memory. The memory array bank can lose its data quickly when power is removed.

The memory array banks include respective row buffers and circuitry of the memory array banks synchronize the accesses of an identified row and the row buffer to change multiple DRAM transactions into a single, complex transaction. This single, complex transaction performs an activation operation and a pre-charge operation of data lines and control lines within the memory array bank once to access an identified row and store the corresponding data in the row buffer. Sense amplifiers are used for these operations. These operations are performed again once to put back modified contents stored in the row buffer to the identified row.

The memory array banks also utilize components of a processing-in-memory (PIM) accelerator. As shown, the memory channel 572D includes the memory array bank 580 that includes the PIM accelerator 582. PIM accelerator 582 includes components such as a PIM register file and a PIM arithmetic logic unit (ALU). The components of the PIM accelerator 582 integrate data processing capability with data storage within a same memory device. In various implementations, the memory channels 572A-572C are instantiated copies of the circuitry of the memory channel 572D. The PIM accelerator 582 is capable of performing quantization operations and dequantization operations dynamically, which offloads the processing circuit die 550 and any other processor die from performing these operations while executing a parallel data application such as a machine learning data model.

In some implementations, die 540 includes control circuit 542. In other implementations, control circuit 542 is located on another die (not shown) or within one of the memory channels (MCs) 572A-572D. Control circuit 542 has the same functionality as control circuit 180 (of FIG. 1) and control circuit 310 (of FIG. 3). The MCs 572A-572D and die 540 can be candidate accelerators used to offload tasks from processing circuit die 550. In various implementations, interposer-based integration can be used whereby the die 540 can be placed next to the processing circuit die 550, and the DRAM dies 570A-570D are stacked directly on top of one another and on top of the processing circuit die 550. Die-stacking technology is a fabrication process that enables the physical stacking of multiple separate pieces of silicon (integrated chips) together in a same package with high-bandwidth and low-latency interconnects. The processing circuit die 550 and the die 540 are stacked side by side on a silicon interposer 530 (or interposer 530). Generally speaking, the interposer 530 is an intermediate layer between the processing circuit die 550 and the die 540 and either flip chip bumps or other interconnects and the package substrate 510. The interposer 530 can be manufactured using silicon or organic materials. Dielectric material, such as silicon dioxide, is also used between adjacent metal layers and within metal layers to provide electrical insulation between signal routes.

In some implementations, each of the DRAM dies 570A-570D and/or each of the memory channels (MCs) 572A-572D is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry of a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

The package substrate 510 is a part of the semiconductor chip package that provides mechanical base support as well as provides an electrical interface for the signal interconnects for both dies within the computing system 500 and external devices on a printed circuit board. The package substrate 510 uses ceramic materials such as alumina, aluminum nitride, and silicon carbide. The package substrate 510 utilizes the interconnect 502, which includes controlled collapse chip connection (C4) interconnections. The interconnect 502 is also referred to as flip-chip interconnection.

The C4 bumps of the interconnect 502 are connected to the interconnects 520. The interconnects 520 include a combination of one or more of bump pads, vertical through silicon vias (TSVs), through-bulk silicon vias, backside vias, horizontal low-latency metal signal routes, and so forth. The size and density of the vertical interconnects and horizontal interconnects that can tunnel through the package substrate 510, the interposer 530, and the processing circuit die 550, the die 540 and DRAM dies 570A-570D varies based on the underlying technology used to fabricate the 3D ICs. The vertical interconnects of the interconnects 520 can provide multiple, large channels for signal routes, which reduces the power consumed to drive signals, minimizes the resistance and capacitance effects on signal routes, and reduces the distances of signal interconnects between the package substrate 510, the interposer 530, and the processing circuit die 550, the die 540 and DRAM dies 570A-570D.

Similar to the vertical low-latency interconnects, the in-package horizontal low-latency interconnects of the interconnects 520 provide reduced lengths of interconnect signals versus long off-chip interconnects when a SiP is not used. The in-package horizontal low-latency interconnects use particular signals and protocols as if the chips, such as the processing circuit die 550, the die 540 and DRAM dies 570A-570D were mounted in separate packages on a circuit board. The SiP of the computing system 500 can additionally include backside vias or through-bulk silicon vias that reach to package external connections used for input/output (I/O) signals and power signals. It is noted that although the terms “left,” “right,” “horizontal,” “vertical,” “row,” “column,” “top,” and “bottom” are used to describe the computing system 500, the meaning of the terms can change as the computing system 500 is rotated or flipped.

As shown, the processing circuit die 550 includes at least one or more processor cores 552A-552B (or cores 552A-552B), a cache 554, a memory controller 560, and a JIT quantization control circuit 542 (or control circuit 542). The processing circuit die 550 can include the functionality of a parallel data processing circuit used to perform operations of a machine learning data model. The processing circuit die 550 can include the functionality of a graphics processing unit (GPU), an accelerated processing unit (APU), a field programmable gate array (FPGA), an application specific integrated circuit (ASIC), a digital signa processor (DSP), or other. Each of the cores 552A-552B includes one or more compute circuits, each with multiple lanes of execution. In an implementation, cache 554 is a last-level cache of a hierarchical cache memory subsystem of the processing circuit die 550. When requested data is not found in the cache memory subsystem, the memory access request is sent to the memory controller 560.

The memory controller 560 includes circuitry to support communication and data transmission with the DRAM dies 570A, 570B, 570C and 570D. In some implementations, the protocol determines values used for information transfer, such as a number of data transfers per clock cycle, signal voltage levels, signal timings, signal and clock phases and clock frequencies. Protocol examples include DDR2 SDRAM, DDR3 SDRAM, GDDR4 (Graphics Double Data Rate, version 4) SDRAM, and GDDR5 (Graphics Double Data Rate, version 5) SDRAM.

In various implementations, the DRAM dies 570A-570D are used to provide a row-based memory to use as a system memory for the computing system 500. In some implementations, the computing system 500 is used by a server that interacts with an external client device with a client-server architectural model. Examples of the client device are a laptop computer, a smartphone, a tablet computer, a desktop computer, or otherwise. In some implementations, each of the computing system 500 and the client device includes a network interface (not shown) supporting one or more communication protocols for data and message transfers through a network. The network interface supports at least the Hypertext Transfer Protocol (HTTP) for communication across the World Wide Web.

The external client device utilizes an online business, such as application running on the computing system 500, through the network, and the application includes a machine learning data model application programming interface (API) that accesses multiple characterizing parameters. Examples of these parameters are a number of input data values in the values to send to an input layer of the machine learning data model, an identifier specifying which set of weight values to use for the machine learning data model, a number of hidden layers for the machine learning data model, a number of nodes or neurons for each of the hidden layers, an indication of an activation function to use in each of the hidden layers, and so on.

In some implementations, the memory channels 572A-572D store weight values, bias values, and input data values for a machine learning data model with a data model executed by the processing circuit die 550, the die 540, or another processor die. In an implementation, the memory channels 572A-572D store a single copy of these data values in a single precision such as the precision of the 32-bit IEEE-754 single-precision floating-point data format or another format. An accelerator is able to reduce (lower) this precision to the precision of the 16-bit bfloat16 data format, the 8-bit fixed-point int8 integer data format, or another lower precision. A quantized machine learning data model uses one or more quantized data values represented in the lower precision based on the weight values, bias values, and input data values represented in the original, higher precision. Computing systems, such as the computing system 500, use a quantized machine learning data model when the computing systems do not use an architecture that efficiently supports the transfer and processing of the higher precision data representations.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
send a data value having a first data format to an accelerator of a plurality of accelerators, each different from a parallel data processing circuit; and
send, to the accelerator, a first indication to cause circuitry of the accelerator to:
replace the first data format of the data value with a second data format different from the first data format of the data value; and
store the data value with the second data format in a memory to be accessed by the parallel data processing circuit during execution of a data model.

2. The apparatus as recited in claim 1, wherein the circuitry is further configured to allow the data value with the second data format to be overwritten in the memory, responsive to receiving a second indication specifying that the parallel data processing circuit has completed accessing the data value with the second data format.

3. The apparatus as recited in claim 1, wherein:
the data model is a machine learning data model; and
the data value is one of a weight value, an activation value and a gradient value.

4. The apparatus as recited in claim 2, wherein the circuitry is further configured to select the second data format based on a memory address range of a memory storage location storing the data value.

5. The apparatus as recited in claim 3, wherein the circuitry is further configured to send the first indication to the accelerator based on one or more of monitored activity levels of the plurality of accelerators and sizes of arrays being processed by the machine learning data model.

6. The apparatus as recited in claim 2, wherein the plurality of accelerators comprises one or more of a processing-in-memory (PIM) accelerator, a direct memory access (DMA) circuit and a digital signal processing circuit (DSPs).

7. The apparatus as recited in claim 3, wherein the second data format has less precision than the first data format.

8. A method, comprising:
sending, by circuitry, a data value having a first data format to an accelerator of a plurality of accelerators, each different from a parallel data processing circuit; and
sending, by the circuitry to the accelerator, a first indication;
responsive to the first indication, circuitry of the accelerator:
replacing the first data format of the data value with a second data format different from the first data format of the data value; and
storing the data value with the second data format in a memory to be available for access by the parallel data processing circuit during execution of a data model.

9. The method as recited in claim 8, further comprising allowing, by the circuitry, the data value with the second data format to be overwritten in the memory, responsive to receiving a second indication specifying that the parallel data processing circuit has completed accessing the data value with the second data format.

10. The method as recited in claim 8, wherein:
the data model is a machine learning data model; and
the data value is one of a weight value, an activation value, and a gradient value.

11. The method as recited in claim 9, further comprising selecting, by the circuitry, the second data format based on a memory address range of a memory storage location storing the data value.

12. The method as recited in claim 10, further comprising sending, by the circuitry, the first indication to the accelerator based on one or more of monitored activity levels of the plurality of accelerators and sizes of arrays being processed by the machine learning data model.

13. The method as recited in claim 9, wherein the plurality of accelerators comprises one or more of a processing-in-memory (PIM) accelerator, a direct memory access (DMA) circuit and a digital signal processing circuit (DSP).

14. The method as recited in claim 10, wherein the second data format has less precision than the first data format.

15. A computing system comprising:
a memory;
a parallel data processing circuit; and
a plurality of accelerators comprising circuitry, each different from the parallel data processing circuit; and
circuitry configured to:
send a data value having a first data format from the memory to a first accelerator of the plurality of accelerators; and
send, to the first accelerator, a first indication to cause circuitry of the first accelerator to:
replace the first data format of the data value with a second data format different from the first data format of the data value; and
store the data value with the second data format in the memory to be available for the parallel data processing circuit executing a data model.

16. The computing system as recited in claim 15, wherein the circuitry is further configured to allow the data value with the second data format to be overwritten in the memory, responsive to receiving a second indication specifying that the parallel data processing circuit has completed accessing the data value with the second data format.

17. The computing system as recited in claim 15, wherein:
the data model is a machine learning data model; and
the data value is one of a weight value, an activation value and a gradient value.

18. The computing system as recited in claim 16, wherein the circuitry is further configured to select the second data format based on a memory address range of a memory storage location storing the data value.

19. The computing system as recited in claim 17, wherein the circuitry is further configured to send the first indication to the first accelerator based on one or more of types of operations being performed by the parallel data processing circuit and available capacity of the memory.

20. The computing system as recited in claim 16, wherein the plurality of accelerators comprises one or more of a processing-in-memory (PIM) accelerator, an artificial intelligence engine (AIE) circuit and an application specific integrated circuit (ASIC).
